(19) United States
(12) Patent Application Publication
(10) Pub. No.: US 2006/0048754 A1
(43) Pub. Date: Mar. 9, 2006

(54) Internal combustion engine, a cylinder head and an injector support

(76) Inventor: Arthur Sadao Naganawa, Sao Bernardo do Campo (BR)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 11/222,302

(22) Filed: Sep. 8, 2005

(30) Foreign Application Priority Data
Sep. 9, 2004 (BR) PI0405556-0

(51) Int. Cl. F02M 61/14

(52) U.S. Cl. 123/470

(57) ABSTRACT

The present invention relates to an internal-combustion engine, particularly an engine that operates according to the Otto cycle or to the Diesel cycle, comprising at least one cylinder head (1) having at least one valve cap (3), the cylinder head (1) and the valve cap (3) defining at least one through bore (2) for positioning at least one injector (5), additionally comprising at least one injector support positioned inside the through bore (2), the support (4) cooperating with the cylinder head (1) and the valve cap (3) and enabling the positioning of the injector (5).

The present invention further relates to a cylinder head (1) and to the injector support (4).

The present invention relates to an internal-combustion engine and to a cylinder head, which are provided with a fuel injection system, wherein each injector is positioned on the head by means of at least one novel and inventive injector support. The present invention also relates to the injector support itself.

Description of the Prior Art

Every internal combustion engine, as for example, the 4-stroke engines that operate according to the Otto cycle and to the Diesel cycle, need a intake system. In the case of Otto engines, the intake system that predominated over decades was the carburetor, but recently it has been replaced, in most cases, by fuel injection systems. On the other hand, the Diesel engines, due to their practical impositions and functional characteristics, have always used fuel injection systems.

Fuel injection systems, in essence, comprise at least one fuel pump and at least one injector, which, at a determined moment, “injects” fuel under pressure, which has been pressurized by the pump. The term “inject” is between inverted commas because in reality an injector is nothing else than a vale that opens at a determined moment to permit pressured fuel to pass.

Therefore, an injector is indispensable in any fuel injection system for internal-combustion engine.

Initially, fuel injection systems were merely mechanical, but with the passage of time electronic injection system have appeared, wherein a central processor (commonly known as electronic injection module) monitors a number of functioning parameters of the engine, for the purpose of injecting the ideal amount of fuel for each situation. In these systems, the opening and closing of the fuel injector (s) is effected by means of electric signals sent by the processing unit.

In order to enable the fuel injection, the injectors have to be positioned within or else substantially close to the combustion chamber (s) of the engine.

Historically, Diesel-cycle engines use injection system in which the injectors inject fuel directly into the combustion chamber, or else into combustion prechambers, which are recesses of smaller capacity positioned in the cylinder head. In this way, the combustion takes place within the cylinder with the desired velocities, guaranteeing, as much as possibly, an optimized functioning of the engine. So, in Diesel engines the injectors are always positioned on the cylinder head and inject fuel directly into the cylinder. By virtue of this characteristic, the fuel injection systems of Diesel engines are called direct injection systems.

Further historically, Otto engines equipped with fuel injection systems have the injectors positioned in the intake manifold, into which the fuel is injected. Then engine then sucks an air-fuel mixture formed in the intake manifold at the moment when the fuel is injected. This injection system is direct.

However, seeking greater operating efficiency of Otto cycle engines, mainly as far as the specific consumption and the reduction of pollutant emission are concerned, the designers have recently dried to developed engines in which the fuel is not injected into the intake manifold, but rather directly into the combustion chamber (s), during the intake phase of its functioning cycle.

In these engines, which are commonly known as direct-injection Otto engines, the positioning of the injector(s) is effected directly on the cylinder head (s). However, this technology is still little diffused.

Then, in engines provided with direct injection, which are mostly Diesel engines, the injectors are always positioned on the cylinder head, so as to inject fuel into the cylinders.

In this type of engine, it is very important to position the injector in a correct and optimized way, so that the injection of fuel into the cylinder can impart advantageous characteristics to the air-fuel mixture (as, for example, control over the burning speed, reduction of pollutant emission, increase in torque and decrease in consumption by the engine, reduction of engine operating noise, etc.).

Historically, internal-combustion engines have an intake valve and an exhaust valve on each cylinder. The cylinder head of must thus configured Otto engines defines a combustion chamber having a triangular or inclined top, so that the positioning of the two valves, of the injector and other components such as ignition plug was facilitated. The ignition plugs and/or the injectors were positioned, as a rule, either directly or laterally on the cylinder head. In the case of Diesel engines, the combustion chamber had a different design. In both cases, however, the positioning of the injector was equivalent, substantially lateral, fixed directly on the cylinder head.

With the technological development, one has tried to increaser the amount of air likely to be admitted by the engine, thereby increasing its performance, which is achieved by using two or more intake valves, generally combined with the use of two exhaust valves. In this way, it is possible to use smaller and lighter valves, and the opening area for admission of air or air-fuel mixture and exhaustion of combustion gases has considerably increased. With this new architecture, the shape of the combustion chambers has had to be altered, so as to enable the correct positioning of the additional valves.

In the case of Otto engines, the most effective solution found was the hemispherical combustion chamber, the shape of which is essentially semispherical, whereas in Diesel engines its shape has varied less.

The great change occurred in the positioning of the injector, which is now central with respect to the valves, that is to say, substantially at the top of the combustion chamber.

Thus, one has created a new problem of positioning injectors, which now invade the area intended for the valve cap on the engine.

The valve cap is a cap whose prime function is to cover the cavity in the cylinder head where the components of the distribution system of the engine are positioned, such as rods and valve springs, valve tappets, camshafts, rockers, etc., which work constantly lubricated. The valve caps now have openings for positioning the injector and small caps that perform the necessary finish. Due to the presence of lubricating oil in that region, it was necessary to provide individual sealing elements for each injector, as well as fixing elements, which raises the manufacture cost of the engine and the maintenance costs, since upon dismounting the injectors of the valve cap, it is necessary to dismount a number of components, replace sealing elements, etc.

An engine provided with a thus configured system can be seen in FIGS. 1 and 2, attached hereto.

### OBJECTIVES OF THE INVENTION

A first objective of the present invention is to provide an internal-combustion engine having at least one fuel injector positioned on the cylinder head through at least one cavity existing at the valve cap, which enables a simple and economical mounting of the injector, with few components, guaranteeing the sealing against leakage of lubricating oil and decreasing the work and costs required in servicing.

A second objective of the present invention is to provide a cylinder-head for use on an internal-combustion engine with means for positioning at least one fuel injector through at least one cavity existing in the valve cap, which guarantees a simple and economical mounting of the injector, with few components, preventing failures in the sealing against leakage of lubricating oil and decreasing the work and costs required in maintenance of the engine equipped therewith.

A third objective of the present invention is to provide an injector support for use on an engine and on a cylinder head such as described above.

### BRIEF DESCRIPTION OF THE INVENTION

The first objective of the present invention is achieved by means of an internal-combustion engine, particularly an engine that operates according to the Otto cycle or the Diesel cycle, comprising at least one cylinder head provided with at least one valve cap, the cylinder head and the valve cap defining at least one through opening for positioning at least one injector. The engine additionally comprises at least one injector support positioned inside the through opening, cooperating with the cylinder head and the valve cap and that enables the positioning of the injector.

The second objective of the present invention is achieved by means of a cylinder head of an internal combustion engine, particularly an Otto cycle engine or Diesel cycle engine, and to which one associated at least one valve cap, the cylinder head and the valve cap defining at least one through opening for positioning at least one injector and additionally comprising at least one injector support positioned inside the through opening. The support cooperates with the cylinder head and the valve cap, enabling the positioning of the injector.

And, finally, the third objective of the present invention is achieved by means of an injector, particularly for use on an internal-combustion engine or on a cylinder head, as defined above, having a substantially tubular shape and comprising at least one end portion for association with the cylinder head.

The present invention has, as advantages, an internal-combustion engine and a cylinder head provided with at least one support for fixing an injector that enables the correct positioning and fixation of the injector, with few fixing components and efficient guarantee against leakage of lubricating oil, reducing the number of components required for assembly and reducing time and servicing costs, thus imparting to the engine greater desirability by virtue of these characteristics. And, what is more important, all the above-mentioned advantages are obtained without drawbacks or negative aspects.

### BRIEF DESCRIPTION OF THE DRAWINGS

The present invention will now be described in greater detail with reference to an embodiment represented in the drawings. The figures show:

FIG. 1 is a perspective view of a cylinder head of an internal-combustion engine of the prior art;

FIG. 1 is a detail view of the cylinder h 14;

FIG. 3 is a perspective partial view of the cylinder head of an internal-combustion engine according to the present invention, without valve cap;

FIG. 4 is a perspective partial view of the cylinder head of the internal-combustion engine according to the present invention, with the valve cap and the injector on;

FIG. 5 is a perspective partial view of the cylinder head of the internal-combustion engine according to the present invention, without the valve cap and without injector support;

FIG. 6 is a perspective partial view of the cylinder head of the internal-combustion engine according to the present invention, with the valve cap and the injector on;

FIG. 7 is a first perspective view of the injector support of the internal-combustion engine according to the present invention;

FIG. 8 is a second perspective view of the injector support of the internal-combustion engine according to the present invention;

FIG. 9 is a bottom view of the injector support of the internal-combustion engine according to the present invention;

FIG. 10 is a first side view of the injector support of the internal-combustion engine according to the present invention;

FIG. 11 is a second side view of the injector support of the internal-combustion engine according to the present invention;

FIG. 12 is a third side view of the injector support of the internal-combustion engine according to the present invention;

FIG. 13 is a fourth side view of the injector support of the internal-combustion engine according to the present invention;

FIG. 14 is a cross-sectional view of the injector support of the internal-combustion engine according to the present invention.

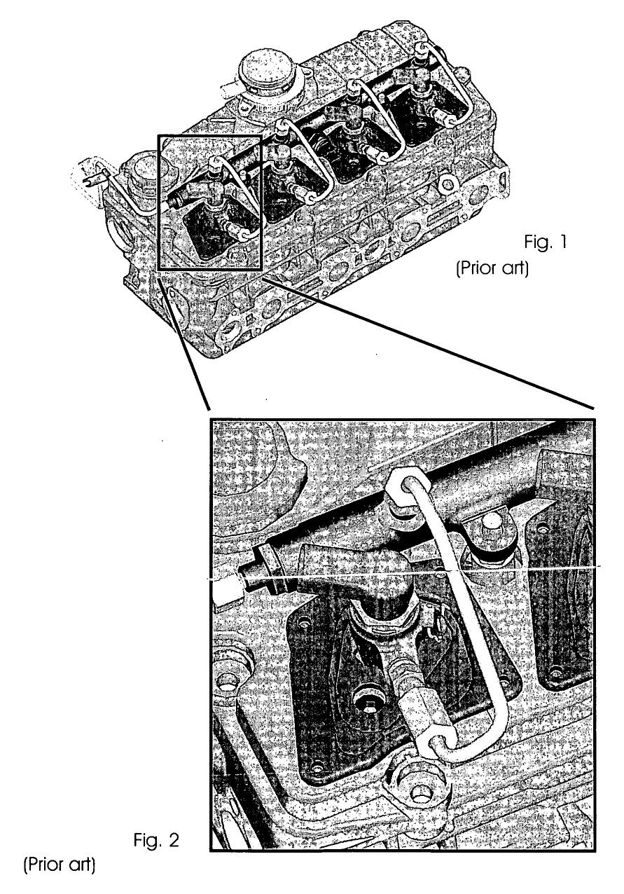

### DETAILED DESCRIPTION OF THE FIGURES

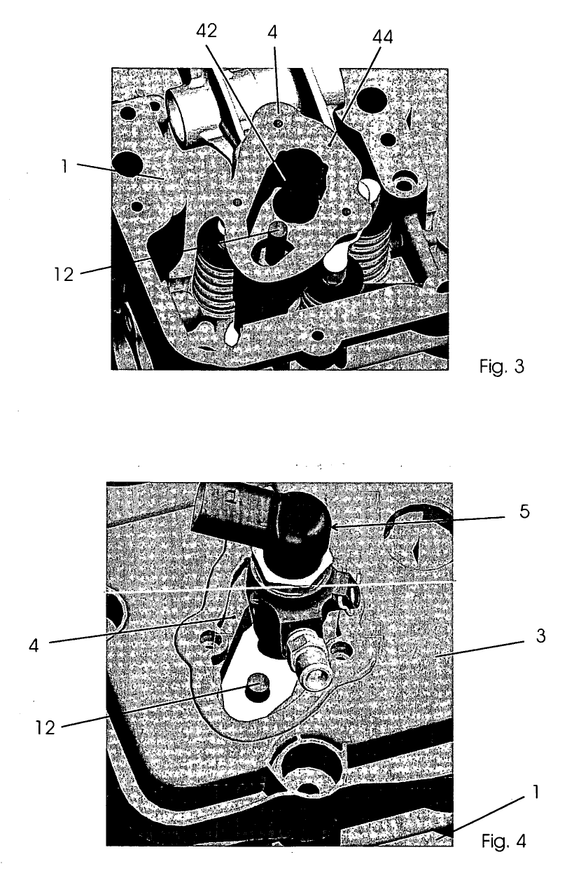

According to a preferred embodiment and as can be seen in FIGS. 3 to 6, the internal-combustion engine of the present invention (not entirely illustrated), which is preferably an engine that operates according to the Diesel cycle, but may also be an Otto-cycle engine, or else any engine whatever, has at least one cylinder head 1, to which at least one valve cap 3 is associated.

The valve cap 3 is a substantially planar part, the function of which is to cover the part of the cylinder head on which internal components of the engine such as acmshaft and/or valves and/or rockers, etc. are positioned. In order to prevent leakage of lubricating oil, an oil seal gasket 13 is provided between the cylinder head 1 and the valve cap 3.

By preference, the engine has only one cylinder head 1, to which preferably at least one valve cap 3 is associated by means of screws (not illustrated), but one may provide an engine having more than one cylinder head 1, such as an engine provided with V-cylinders.

Further as far as the preferred embodiment of the engine of the present invention is concerned, the cylinder head 1 is cast in aluminum alloy, whereas the valve cap 3 is plastic injected. Evidently, however, the cylinder head 1 may be made from other materials, such as cast iron, for example, while the valve cap may be stamped in steel, aluminum, cast in aluminum alloy, etc.

The cylinder head 1 further comprises a single pressurized fuel-supply tubing 9, attached to the valve cap 3, which feeds at least one injector 5. In the engine illustrated in the figures, four injectors 5 can be seen, but it is evident that this number may vary, if necessary or desirable, mainly depending upon the variation of the number of engine cylinders (normally, one injector per cylinder, mainly in Diesel engines).

As will be better defined hereinafter, the injector 5 is positioned on the cylinder head 1 by means of a respective injector support 4.

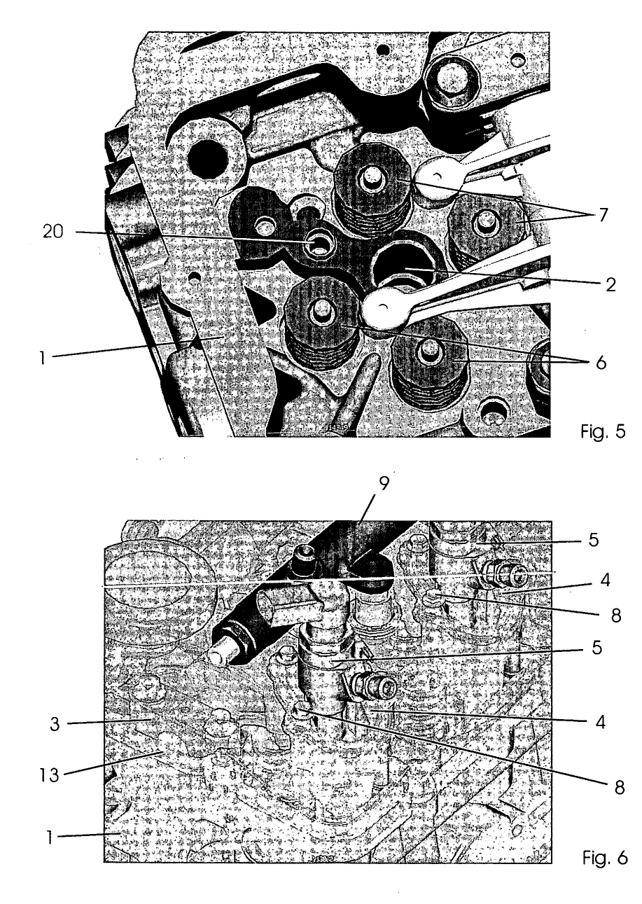

In order to enable the positioning of the injector 5, the cylinder head 1 and the valve cap 3 define at least one through opening 2, which has a first bored end at the cylinder head 1 (clearly illustrated in FIG. 5) and an opposite second bored end, provided at the valve cap 3. The first bored end further enables communication with the inside of the engine cylinder (not shown), and that is where the pressurized fuel of the injection system will be injected through the injector 5.

Preferably, the first bored end of the through opening 2 is a cylindrical opening substantially perpendicular to the plane defined by the cylinder head 1 and is positioned between the two intake valves 6 and the two exhaust valves 7 of the engine, concentrically to them. This occurs because the engine of the preferred embodiment has four valves per cylinder, but it is evident that one may conceive any engine whatever provided with at least one intake valve 6 and at least one exhaust valve 7. It is also evident that the positioning of the cylindrical opening may vary with respect to the valves 6, 7, as long as it enables communication with the inside of the cylinder and as long as it is an integral part of the through opening 2 delimited by the cylinder head 1 and by the valve cap 3.

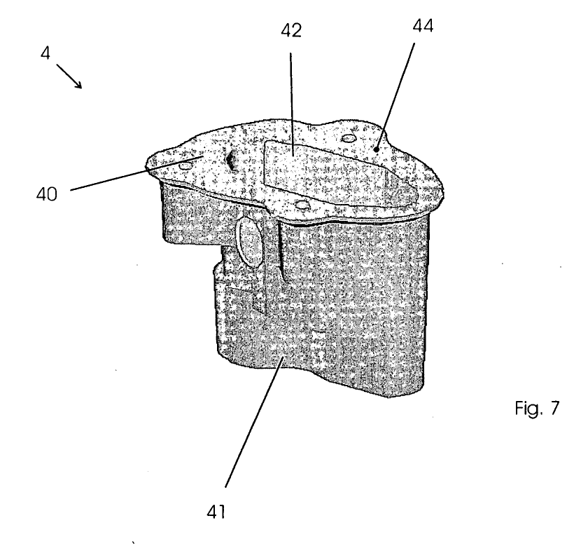

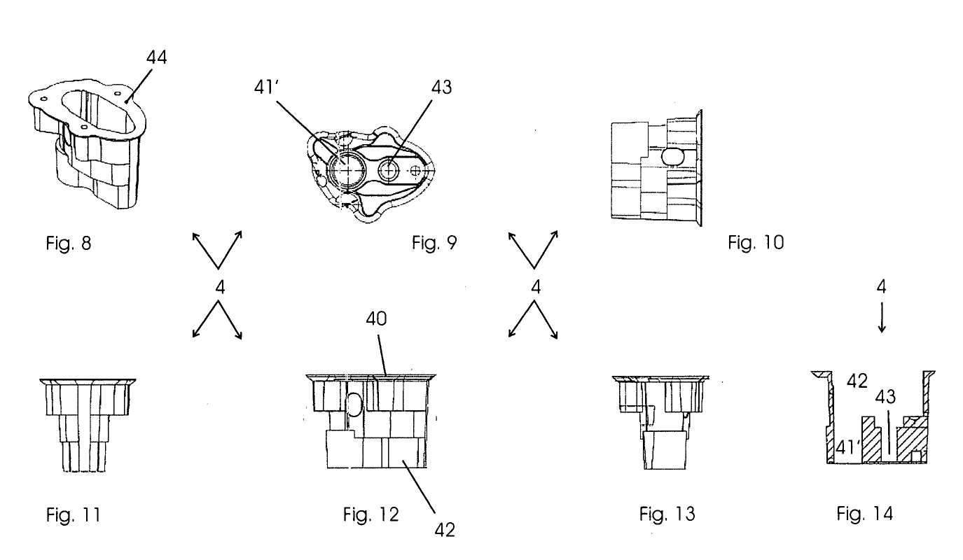

In order to enable the correct positioning of each injector 5, at least one injector support 4 is provided; and in the preferred embodiment of the engine of the present invention four such supports 4 are provided. The support is visible particularly ion FIGS. 3 and 7-14.

As mentioned before, the support 4 enables the correct positioning of the injector 5 on the cylinder head 1 of the engine.

By preference, one support 4 is provided for positioning each injector 5, but it is evident that one may devise one support for positioning two or more injectors 5, if necessary or desirable. For example, one might devise a single support that could position two injectors 5 of two neighboring or adjacent cylinders of an engine.

By preference the support 4 is substantially tubular in shape with a substantially oblong cross-section and defines a bored cavity 42 to position the injector 5.

The cavity 42 is delimited by a fist end portion 40 of the support, corresponding to its opening, and by a second end portion 41 opposite the first one, provided with at least one opening 41′ (by preference having a diameter preferably smaller than that of the end portion 40). This second opening 41′ is preferably but not compulsorily cylindrical and communicates with the cavity 42. When the support 4 is positioned on the engine, the first end portion 40 is associated to the valve cap 3 and the second end portion 41 is associated to the cylinder head 1.

The first end portion 40 further has a substantially planar contact surface 44, and it is the latter that effectively cooperates with the valve cap 3, and the second end portion 41 further has an orifice 43 to enable the screwing of the body 4 onto the cylinder head 1 and a stud, which cooperates with a respective tear 20 in the cylinder head 1. However, this surface is optional.

Notwithstanding, the support 4 may have any shape other than the presently disclosed one, provided that it is functional and cooperates with the valve cap 3 and with the cylinder head 1, and as long as it enables its positioning with respect to the other components existing on the cylinder head.

However, evidently the orifice 43 and the stud 12 are merely optional, since the support 4 may be fixed to the cylinder head 1 by means other than screwing (gluing, interference fixation, etc.).

It should be further noted that the support 4 is preferably constituted by cast metal, but it may be made from any other necessary or desirable material.

When the support 4 is positioned on the engine, the planar contact surface 44 of the first end portion remains substantially parallel to the valve cap 3, and preferably a sealing element as a gasket (not shown) is provided, which prevents possible leakages of oil existing on the cylinder head 1 to lubricate movable mechanical elements already discussed, such as valves, rockers, etc. Alternatively, one may use glue as a sealing element or even may not use any additional sealing element, if the friction between the surface 44 and the valve cap 3 is sufficient to guarantee that no leakage will occur.

If the orifice 43 and the stud 12 are provided, they will be correctly fitted in order to guarantee correct geometric positioning of the support 4 and keep it in that position, without shearing.

The injector 5 is positioned on the support so that its needle will extend into the cylinder through the opening 41′ and bored end 2, thereby guaranteeing that fuel will be injected into the cylinder.

The injector body projects out of the cavity 42 of the body 2 and sticks out with respect to the valve cap 3, enabling connection of the pressurized individual fuel line that comes form the pressurized single fuel-feed line 9 and, as the case may be, an electric shock commanding the opening or closing of the injector, which, as a rule, is controlled by a electronic processing module.

As already mentioned, the securing of the support 4 with the cylinder head 1 is guaranteed by means of a stud or another functional element, and the securing of the support with the valve cap is preferably guaranteed by means of three fixing screws 8, which presses the cap 3 and the surface 44 of the support 4 against each other (thus helping to prevent leakages of lubricating oil through that point).

The positioning or the injector 5 on the support 4, in turn, prevents any communication between the interior of the cylinder and the outside.

It should also be noted that the presently described cylinder head 1 too is an invention, if analyzed in isolation, as well as the injection support 4, since they are novel and inventive.

Generically speaking, the cylinder head 1 of an internal-combustion engine, particularly an engine that operates according to the Otto cycle or the Diesel cycle, to which at least one valve cap 3 is associated, defines together with the valve cap 3 at least one through opening 3 for positioning at least one injector 5, and additionally comprises at least one injector support 4 positioned inside the through opening 2, the support 4 cooperating the cylinder head 1 and the valve cap 3 and enabling the positioning of the injector 5.

The injector 4, in a general way, is particularly designed for use on an internal-combustion engine and on the cylinder head defined now and has a substantially tubular shape, comprising at least one end portion 40, 41 for association with the cylinder head 1.

A preferred embodiment having been described, one should understand that the scope of the present invention embraces other possible variations, being limited only by the contents of the accompanying claims, which includes the possible equivalents.

I claim:

1. An internal-combustion engine, particularly an engine that operates according to the Otto cycle or to the Diesel cycle, comprising at least one cylinder head (1) having at least one valve cap (3), the cylinder head (1) and the valve cap (3) defining at least a through bore (2) for positioning at least one injector (5), characterized by additionally comprising at least one injector support (4) positioned inside the through bore (2), the support (4) cooperating with the cylinder head (1) and the valve cap (3) and enabling the positioning of the injector (5).

2. An engine according to claim 1, characterized in that the through bore (2) has a first bored end in the cylinder head (1) and a second bored end in the valve cap (3).

3. An engine according to claim 1 or 2, characterized in that the injector support (4) is tubular in shape with a substantially oblong cross-section and defines a bored cavity (42) for positioning the injector (5).

4. An engine according to claim 3, characterized in that the support (4) has a first end portion (40), o for association with the valve cap (3), corresponding to the cavity opening (42), and a second opposite end portion (41), provided with at least one cylindrical small opening (41′) communicating with the cavity (42) and cooperating with the first bored end of the opening (2) foreseen in the cylinder head (1).

5. An engine according to any of claims 2 to 4, characterized in that the first bored end of the opening (2) is positioned substantially perpendicular to the plane defined by the cylinder head (1), between at least one intake valve (6) and at least one exhaust valve (7).

6. An engine according to any of claims 2 to 5, characterized in that the association between the first end (40) of the support (4) and the valve cap (3) is effected with at least one sealing element.

7. An engine according to any of claims 2 to 6, characterized in that the support (4) is fixed to the valve cap (3) by means of three fixing stud bolts (8).

8. A cylinder head of an internal-combustion engine, particularly an engine that operates according to the Otto cycle or to the Diesel cycle, to which at least one valve cap (3) is associated, the cylinder head (1) and the valve cap (3) defining at least one through bore (2) for positioning at least one injector (5), characterized by additionally comprising at least one injector support (4) inside the through bore (2), the support (4) cooperating with the cylinder head (1) and the valve cap (3) and enabling the positioning of the injector (5).

9. A cylinder head according to claim 8, characterized in that the through bore (2) has a first bored end in the cylinder head (1) and a second bored end in the valve cap (3).

10. A cylinder head according to claim 8 or 9, characterized in that the injector support (4) is tubular in shape with a substantially oblong cross-section and defines a bored cavity (42) for positioning the injector (5).

11. A cylinder head according to claim 10, characterized in that the support (4) has a first end portion (40), for association with the valve cap (3), corresponding to the cavity opening (42), and a second opposite end portion (41), provided with at least one cylindrical small opening (41′) communicating with the cavity (42) and cooperating with the first bored end of the opening (2).

12. A cylinder head according to any of claims 9 to 11, characterized in that the first bored end of the opening (2) is positioned substantially perpendicular to the plane defined by it, between at least one intake valve (6) and at least one exhaust valve (7).

13. A cylinder head according to any of claims 9 to 12, characterized in that the association between the first end (40) of the support (4) and the valve cap (3) is effected with at least one sealing element.

14. A cylinder head according to any of claims 9 to 13, characterized in that the support (4) is fixed to the valve cap (3) by means of three fixing bolts (8).

15. An injector support, particularly for use on an internal-combustion engine defined in claims 1 to 7 or on a cylinder head as defined in claims 8 to 14, characterized in that it is substantially tubular in shape and comprises at least one end portion (40, 41) for association with the cylinder head (1).

16. A support according to claim 15, characterized in that it is tubular in shape with a substantially oblong cross-section and defines a bored cavity (42) for positioning at least one injector (5).

17. A support according to claim 16, characterized by having a first end portion (40) for association with the valve cap (30), corresponding to the cavity opening (42), and a second opposite end portion (41), provided with at least one cylindrical small opening (41′) communicating with the cavity (42).
